(19) United States
(12) Patent Application Publication
(10) Pub. No.: US 2020/0290253 A1
(43) Pub. Date: Sep. 17, 2020

(54) OPTICAL RECEPTACLE MANUFACTURING METHOD AND MOLD USED FOR SAME

(71) Applicant: ENPLAS CORPORATION, Kawaguchi-shi, Saitama (JP)

(72) Inventor: Yuki SAITO, Saitama (JP)

(21) Appl. No.: 16/646,475

(22) PCT Filed: Sep. 13, 2018
(86) PCT No.: PCT/JP2018/034013

§ 371 Date: Mar. 11, 2020

(30) Foreign Application Priority Data
Sep. 25, 2017 (JP) 2017-183976

(51) Int. Cl. B29C 45/26; B29D 11/00; G02B 6/42

(52) U.S. Cl. CPC B29C 45/26; G02B 6/423; G02B 6/4214; B29D 11/0075

(57) ABSTRACT

Provided is a method for manufacturing an optical receptacle with which the occurrence of bending of a guide pin hole can be suppressed. The method for manufacturing an optical receptacle of the present invention includes an injection step of injecting a resin through a resin injection port of a mold into a cavity of the mold, and a solidification step of solidifying the resin in the cavity of the mold. The cavity of the mold has a protruding portion for forming a recessed portion in a main body of an optical receptacle, a pair of pins for forming a pair of guide pin holes in the main body of the optical receptacle, and a pair of pin-retaining portions. In the injection step, the mold during the injection of the resin is in a state in which the pair of pins are respectively disposed on two end sides of the protruding portion, the resin injection port is disposed so that the resin flows from one end side of the pair of pins toward opposing faces of the pins that oppose each other, one of the pin-retaining portions is disposed in contact with a side of a corresponding one of the pins that is opposite to the opposing face thereof, and the other of the pin-retaining portions is disposed in contact with a side of the other of the pins that is opposite to the opposing face thereof.

### TECHNICAL FIELD

The present invention relates to a method for manufacturing an optical receptacle and a mold for use in the method.

### BACKGROUND ART

An optical module that includes a light-emitting element, such as a surface emitting laser, and an optical receptacle is used in optical communications performed using optical fibers. The optical receptacle has a lens portion that allows light to travel through, a reflective surface that reflects light, and an exit surface from which light is emitted toward the optical fiber and which is optically connected to the optical fiber, and the optical receptacle is disposed between the light-emitting element and the optical fiber (Patent Document 1).

The positioning of the optical fiber with respect to the optical receptacle is performed with use of, for example, the optical receptacle in which a guide pin hole is formed and the optical fiber to which a connector having a guide pin is attached. With this configuration, the arrangement of the optical receptacle and the optical fiber can be fixed by inserting the guide pin of the connector into the guide pin hole of the optical receptacle.

In general, the above-described optical receptacle can be manufactured as a single-piece object through resin injection molding. An optical receptacle provided with the above-described guide pin hole is molded with use of a mold in which a pin for forming a guide pin hole is placed at a position corresponding to the guide pin hole. With this mold, in the resulting molded body, a space having the same shape as the pin is formed at the position at which the pin has been placed, and this space can be used as the guide pin hole. However, in the molding of an optical receptacle using the above-described mold, bending may occur in the guide pin hole of the resulting molded body. If bending occurs in the guide pin hole of the optical receptacle, a problem arises in that the guide pin of the connector cannot be smoothly inserted into the guide pin hole.

### CITATION LIST

### Patent Documents

[Patent Document 1]: JP 2013-137507A

### SUMMARY OF INVENTION

### Technical Problem

To address the above-described problem, an object of the present invention is to provide a method for manufacturing an optical receptacle with which the occurrence of bending of a guide pin hole can be suppressed, and a mold for use in the method.

### Solution to Problem

In order to achieve the above-described object, a method for manufacturing an optical receptacle of the present invention includes:

an injection step of injecting a resin through a resin injection port of a mold into a cavity of the mold; and

a solidification step of solidifying the resin in the cavity of the mold,

the cavity of the mold having:
a protruding portion for forming a recessed portion in a main body of an optical receptacle,
a pair of pins for forming a pair of guide pin holes in the main body of the optical receptacle, and
a pair of pin-retaining portions,

wherein, in the injection step, the mold during the injection of the resin is in a state in which:
the pair of pins are respectively disposed on two end sides of the protruding portion,
the resin injection port is disposed so that the resin flows from one end side of the pair of pins toward opposing faces of the pins that oppose each other, and
one of the pin-retaining portions is disposed in contact with a side of a corresponding one of the pins that is opposite to the opposing face thereof, and the other of the pin-retaining portions is disposed in contact with a side of the other of the pins that is opposite to the opposing face thereof.

An optical receptacle mold of the present invention is a mold that has a cavity for molding an optical receptacle and that is used in the above-described method for manufacturing an optical receptacle,

the cavity having:
a protruding portion for forming a recessed portion in a main body of an optical receptacle,
a pair of pins for forming a pair of guide pin holes in the main body of the optical receptacle, and
a pair of pin-retaining portions,
the pair of pins being respectively disposed on two ends (both ends) of the protruding portion,
a resin injection port being disposed so that the resin flows from one end side of the pair of pins toward opposing faces of the pins that oppose each other, and
one of the pin-retaining portions being disposed in contact with a side of a corresponding one of the pins that is opposite to the opposing face thereof, and the other of the pin-retaining portions being disposed in contact with a side of the other of the pins that is opposite to the opposing face thereof.

### Advantageous Effects of Invention

According to the method for manufacturing an optical receptacle as well as the optical receptacle mold of the present invention, the pins for forming the guide pin holes and the pin-retaining portions are arranged under the above-described conditions, and thereby the occurrence of bending of the pins can be suppressed during resin molding. Thus, according to the present invention, it is possible to manufacture an optical receptacle while suppressing the occurrence of bending of the guide pin holes.

### BRIEF DESCRIPTION OF DRAWINGS

FIG. 1 schematically shows an example of an optical receptacle that is obtained according to the present invention; FIG. 1(A) is a perspective view as seen from a top side, FIG. 1(B) is a top view, FIG. 1(C) is a perspective view as seen from a bottom side, FIG. 1(D) is a bottom view, FIG. 1(E) is a front view, and FIG. 1(F) is a cross-sectional view as seen in the direction indicated by I-I in FIG. 1(E).

FIG. 2 is a perspective view schematically showing an example of an optical receptacle mold according to an embodiment of the present invention, and shows a state in which three mold components constituting the mold are disassembled.

FIG. 3(A) shows a rear face of a front mold of the present embodiment that opposes a rear mold, and FIG. 3(B) shows a front face of the rear mold of the present embodiment that opposes the front mold.

FIG. 4(A) is a side view showing a state in which an upper mold, the front mold, and the rear mold of the present embodiment are disassembled, and FIG. 4(B) is a side view showing a state in which the upper mold, the front mold, and the rear mold are assembled.

FIG. 5 is a top view showing a state in which the front mold and the rear mold of the present embodiment are assembled.

### DESCRIPTION OF EMBODIMENTS

According to the method for manufacturing an optical receptacle of the present invention, for example, in the injection step, the mold has the resin injection port in line with end portions of the pair of pins on the one end side, and between a direction that is parallel to an up-down direction and orthogonal to an axial direction of one of the pins and a direction that is parallel to the up-down direction and orthogonal to an axial direction of the other of the pins at the end portions.

According to the method for manufacturing an optical receptacle of the present invention, for example, in the injection step, in the mold, the pin-retaining portions are each disposed at or near the center of a corresponding one of the pins in an axial direction thereof.

According to the optical receptacle mold of the present invention, for example, the mold has the resin injection port in line with end portions of the pair of pins on the one end side, and between a direction that is parallel to an up-down direction and orthogonal to an axial direction of one of the pins and a direction that is parallel to the up-down direction and orthogonal to an axial direction of the other of the pins.

According to the optical receptacle mold of the present invention, for example, the pin-retaining portions are each disposed at or near the center of a corresponding one of the pins in the axial direction thereof.

The method for manufacturing an optical receptacle as well as the optical receptacle mold of the present invention are characterized in that, as described above, during the molding of the resin, the pin-retaining portions are arranged under the above-described conditions, and there is no particular limitation on the other structures and conditions. The method for manufacturing an optical receptacle of the present invention can be performed by using the optical receptacle mold of the present invention, for example.

Hereinafter, a method for manufacturing an optical receptacle, as well as an optical receptacle mold (also referred to simply as “mold” below), of the present invention will be described by way of examples using the drawings. The method for manufacturing an optical receptacle and the mold of the present invention are neither restricted nor limited to the following embodiments.

### Optical Receptacle

First, prior to describing a method for manufacturing an optical receptacle as well as a mold of the present embodiment, the structure of an optical receptacle that is to be molded using the mold and the method for manufacturing an optical receptacle of the present embodiment will be described by way of examples using the drawings.

The optical receptacle is a device that is disposed, in an optical module, between an optical-electrical converter having an optical-electrical conversion element and an optical transmitter. In the optical module, the optical-electrical converter and the optical transmitter are optically coupled to each other by the optical receptacle and can be used for, for example, optical communications. The optical-electrical converter may have, for example, a light-emitting element or a light-receiving element as the optical-electrical conversion element. If the optical-electrical converter has the light-emitting element, the optical receptacle is a device that receives light emitted from the light-emitting element of the optical-electrical converter, allows the light to travel through, and emits the light toward an end portion of the optical transmitter. The light that has entered the optical receptacle from the optical-electrical converter and has been emitted toward the optical transmitter from the optical receptacle contains, for example, communication information and is also referred to as transmitted light. If the optical-electrical converter has a light-receiving element as described above, the optical receptacle is a device that receives light emitted from the optical transmitter, allows the light to travel through, and emits the light toward the light-receiving element of the optical-electrical converter. The light that has entered the optical receptacle from the optical transmitter and has been emitted toward the optical-electrical converter from the optical receptacle contains, for example, communication information and is also referred to as received light. The light-emitting element and the light-receiving element are also collectively referred to as the “optical-electrical conversion elements”.

The optical receptacle may also have, for example, a reflective portion that reflects light (the above-described transmitted light or received light) that has entered the inside of the optical receptacle, if necessary.

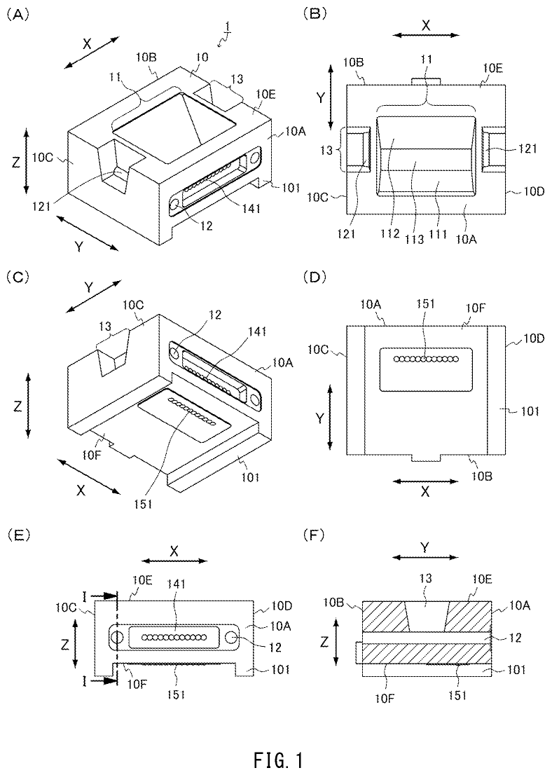

FIG. 1 schematically shows an example of the above-described optical receptacle. In FIG. 1, FIG. 1(A) is a perspective view as seen from an upper side, FIG. 1(B) is a plan view (top view) as seen from the upper side, FIG. 1(C) is a perspective view as seen from a lower side, FIG. 1(D) is a plan view (bottom view) as seen from the lower side, FIG. 1(E) is a plan view (front view) as seen from a front side, and FIG. 1(F) is a cross-sectional view as seen in the direction indicated by I-I in FIG. 1(E). In FIG. 1, the arrow X indicates a left-right direction (also referred to as the width direction), the arrow Y indicates a front-rear direction (length direction), and the arrow Z indicates a height direction (also referred to as the thickness direction). In the description of the present embodiment, for the sake of convenience, the direction in which the optical receptacle is to oppose the optical-electrical conversion element is regarded as a downward direction, and the direction in which the optical receptacle is to be optically connected to the optical transmitter is regarded as a forward direction.

An optical receptacle 1 has a light-transmitting main body 10, and the main body 10 has a substantially rectangular parallelepiped shape. For the sake of convenience, the face of the main body 10 shown in the front view of FIG. 1(E) will be referred to as a front face 10A, the face that opposes the front face 10A will be referred to as a rear face 10B, the faces that are connected to the front face 10A and the rear face 10B will be referred to as lateral side faces 10C and 10D, the face shown in the top view of FIG. 1(B) will be referred to as an upper face 10E, and the face shown in the bottom view of FIG. 1(D) will be referred to as a lower face (also referred to as the bottom face) 10F.

In the optical receptacle 1, the lower face 10F includes a first optical surface 151, the front face 10A includes a second optical surface 141, and the upper face 10E includes a reflective surface 111. During use, the optical receptacle 1 is disposed such that the lower face 10F opposes the optical-electrical conversion element of the optical-electrical converter, while the optical transmitter is disposed such that its end portion opposes the front face 10A of the optical receptacle 1. If the optical-electrical converter has the above-described light-emitting element, the first optical surface 151 in the lower face 10F serves as an entrance portion through which light emitted from the light-emitting element enters the inside of the main body 10, the second optical surface 141 in the front face 10A serves as an exit portion through which light from the main body 10 is emitted toward the optical transmitter, and the reflective surface 111 in the upper face 10E serves as a reflective portion that reflects light traveling from the first optical surface 151 toward the second optical surface 141. Alternatively, if the optical-electrical converter has the above-described light-receiving element, the first optical surface 151 in the lower face 10F serves as an exit portion through which light from the main body 10 is emitted toward the light-receiving element, the second optical surface 141 in the front face 10A serves as an entrance portion through which light emitted from the optical transmitter enters the inside of the main body 10, and the reflective surface 111 in the upper face 10E serves as a reflective portion that reflects light traveling from the second optical surface 141 toward the first optical surface 151.

In the present embodiment, as shown in FIGS. 1(C) and 1(D), the first optical surface 151 is formed on the lower face 10F side. Specifically, as shown in FIGS. 1(C) and 1(D), the lower face 10F has a plurality of first optical surfaces 151, which are contiguously arranged in the direction X. The first optical surfaces 151 are a plurality of protruding portions that protrude in the downward direction, and may be, for example, convex lenses. The convex lenses (first optical surfaces 151) have, for example, a circular shape in a plan view as seen from the lower face 10F side in FIG. 1(D), and are spherical or aspherical.

The shape of the first optical surface 151 is not particularly limited, and may be, for example, a flat planar shape or a nonplanar shape, such as a curved surface. Moreover, the nonplanar shape may be, for example, a convex surface shape or a concave surface shape.

The number of first optical surfaces 151 is not particularly limited, and may be, for example, one, or two or more. In the latter case, the number of first optical surfaces 151 may be, for example, four, eight, twelve, or the like. If the first optical surfaces 151 are the lenses for example, the number of lenses is not particularly limited and can be determined as appropriate depending on, for example, the number of, and the number of rows of, optical-electrical conversion elements mounted on a substrate in the optical-electrical converter. For example, if n (n is a positive integer) rows of optical-electrical conversion elements are arranged in the optical-electrical converter, it is preferable that the same number of rows of lenses are formed in the optical receptacle 1.

Preferably, when the optical receptacle 1 is disposed on the optical-electrical converter for example, the optical axis of the first optical surface 151 matches the central axis (central beam) of light emitted from or entering the optical-electrical conversion element. Moreover, the optical axis of the first optical surface 151 may be perpendicular to a region of the lower face 10F outside the first optical surface 151, for example.

The lower face 10F may, for example, further have a pair of protruding portions 101 that protrude downward at the sides on two ends thereof in the left-right direction (direction X). In the optical receptacle 1, the pair of protruding portions 101 serve as installation portions when, for example, the optical receptacle 1 is placed on the optical-electrical converter.

In the present embodiment, as shown in FIGS. 1(A) and 1(B), the reflective surface 111 is formed on the upper face 10E side. Specifically, as shown in FIGS. 1(A) and 1(B), the upper face 10E has a recessed portion 11. The inside of the recessed portion 11 has a pair of inclined surfaces 111 and 112 that together form a downwardly tapered shape in the front-rear direction (direction Y), and a bottom surface 113 between the pair of inclined surfaces 111 and 112. The inclined surface 111, which is the one of the pair of inclined surfaces 111 and 112 that is closer to the front face 10A, constitutes a reflective surface. In the following description, the inclined surface 111 that is closer to the front face 10A will be referred to as the reflective surface 111, and the inclined surface 112 that is closer to the rear face 10B will be referred to as the opposing surface. If the optical-electrical converter has the above-described light-emitting element, the reflective surface 111 has an inclination angle with respect to the optical axis of incident light from the first optical surface 151 and is located above the first optical surface 151, and therefore serves as a reflective portion that reflects light traveling from the first optical surface 151 toward the second optical surface 141, for example. On the other hand, if the optical-electrical converter has the above-described light-receiving element, the reflective surface 111 has an inclination angle with respect to the optical axis of incident light from the second optical surface 141 and is located rearward of the second optical surface 141, and therefore serves as a reflective portion that reflects light traveling from the second optical surface 141 toward the first optical surface 151, for example. The reflective surface 111 and the opposing surface 112 are, for example, flat surfaces.

The inclination angle of the reflective surface 111 is not particularly limited, and may be, for example, an angle larger than the critical angle. As a specific example, the inclination angle with respect to the optical axis of incident light from the first optical surface 151 is 45°±5°. The inclination angle of the reflective surface 111 can also be defined with respect to the first optical surface 151 in the lower face 10F, for example. The inclination angle of the reflective surface 111 can be expressed as, for example, an inclination angle with respect to a region of the lower face 10F outside the first optical surface 151, in which case the inclination angle is 45°±5°, for example.

In the present embodiment, as shown in FIGS. 1(A) and 1(E), the second optical surface 141 is formed on the front face 10A side. Specifically, as shown in FIGS. 1(A) and 1(E), the front face 10A has a plurality of second optical surfaces 141, which are contiguously arranged in the direction X. The second optical surfaces 141 are a plurality of protruding portions that protrude forward, and may be, for example, convex lenses. The convex lenses (second optical surfaces 141) have, for example, a circular shape in a plan view as seen from the front face 10A side in FIG. 1(E), and are spherical or aspherical.

The shape of the second optical surface 141 is not particularly limited, and may be, for example, a flat planar shape or a nonplanar shape, such as a curved surface. Moreover, the nonplanar shape may be, for example, a convex surface shape or a concave surface shape.

The number of second optical surfaces 141 is not particularly limited, and may be, for example, one, or two or more. In the latter case, the number of second optical surfaces 141 may be, for example, four, eight, twelve, or the like. If the second optical surfaces 141 are lenses for example, the number of lenses is not particularly limited, and can be determined as appropriate depending on, for example, the number of, and the number of rows of, optical transmitters. For example, if n (n is a positive integer) rows of optical transmitters are arranged, it is preferable that the same number of rows of lenses are formed in the optical receptacle 1.

Preferably, when the optical receptacle 1 is disposed opposing the end face of the optical transmitter for example, the optical axis of the second optical surface 141 matches the central axis (central beam) of light emitted from or entering the optical transmitter. Moreover, the optical axis of the second optical surface 141 may be perpendicular to a region of the front face 10A outside the second optical surface 141, for example.

The optical receptacle 1 has a pair of guide pin holes 12 extending from the front face 10A toward the rear face 10B in the front-rear direction (direction Y). Each of the guide pin holes 12 is a through hole that penetrates from the front face 10A to the rear face 10B. The guide pin holes 12 are formed between the recessed portion 11 having the reflective surface 111 and the lateral side faces 10C and 10D respectively, at positions outward of the second optical surface 141 of the front face 10A in the width direction (direction X).

The pair of guide pin holes 12 are holes into which a pair of guide pins of a connector attached to the optical transmitter are to be inserted during use of the optical receptacle 1. The shape of the guide pin holes 12 is not particularly limited, and may be, for example, a shape that corresponds to the shape of the guide pins. For example, a cylindrical space can be given as a specific example of the shape of the guide pin holes 12. The positions of the pair of guide pin holes 12 are not particularly limited, and may be, for example, positions that correspond to the positions of the pair of guide pins of the connector. Moreover, it is sufficient that the pair of guide pin holes enable coupling to the connector, and regarding the arrangement thereof, the guide pin holes may or may not be parallel to each other, for example.

Next, the behavior of light via the optical receptacle 1 will be described. During use, the optical receptacle 1 is disposed on the optical-electrical converter so that the first optical surface 151 opposes the optical-electrical converter. On the other hand, a connector having a pair of guide pins is attached to the optical transmitter, and the pair of guide pins of the connector are inserted into the pair of guide pin holes 12 of the optical receptacle 1. Thus, an end portion of the optical transmitter opposes the second optical surface 141 of the optical receptacle 1, and the optical transmitter and the optical receptacle 1 can be optically connected to each other.

If the optical-electrical converter has a light-emitting element, when light that contains communication information is emitted from the light-emitting element of the optical-electrical converter, the light enters the optical transmitter via the optical receptacle 1. Specifically, first, when light that contains communication information is emitted from the light-emitting element of the optical-electrical converter, the light travels into the optical receptacle 1 through the first optical surface 151. Then, when the traveling light reaches the reflective surface 111 of the recessed portion 11 that is located above the first optical surface 151, the light that has reached the reflective surface 111 is reflected toward the second optical surface 141 in accordance with the inclination angle of the reflective surface 111. Here, in order to cause light entering the inside of the optical receptacle 1 to reach the second optical surface 141, the inclination angle of the reflective surface 111 is set so that light is reflected toward the second optical surface 141, for example. Then, the reflected light is emitted from the second optical surface 141 in the front face 10A and received at the end portion of the optical transmitter.

If the optical-electrical converter has a light-receiving element, when light that contains communication information is emitted from the optical transmitter, the light enters the optical-electrical converter via the optical receptacle 1. Specifically, first, when light that contains communication information is emitted from the optical transmitter, the light travels into the optical receptacle 1 through the second optical surface 141. Then, when the traveling light reaches the reflective surface 111 of the recessed portion 11, which is located rearward of the second optical surface 141, the light that has reached the reflective surface 111 is reflected toward the first optical surface 151 in accordance with the inclination angle of the reflective surface 111. Here, in order to cause light entering the inside of the optical receptacle 1 to reach the first optical surface 151, the inclination angle of the reflective surface 111 is set so that light is reflected toward the first optical surface 151. Then, the reflected light is emitted from the first optical surface 151 and received by the light-receiving element of the optical-electrical converter.

### Optical Receptacle Mold

Next, a mold of the present embodiment will be described by way of examples using the drawings. The mold of the present embodiment can be used in resin injection molding, for example. The above-described optical receptacle can be molded using the mold of the present embodiment, and therefore, with regard to the size, shape, and position of various sections of the mold, the descriptions of the corresponding sections of the optical receptacle can be applied, for example.

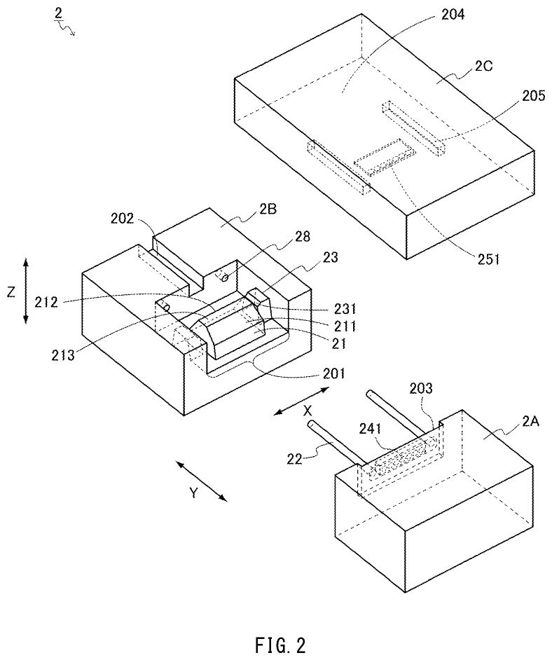

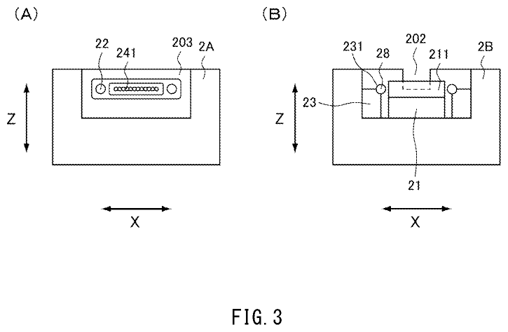

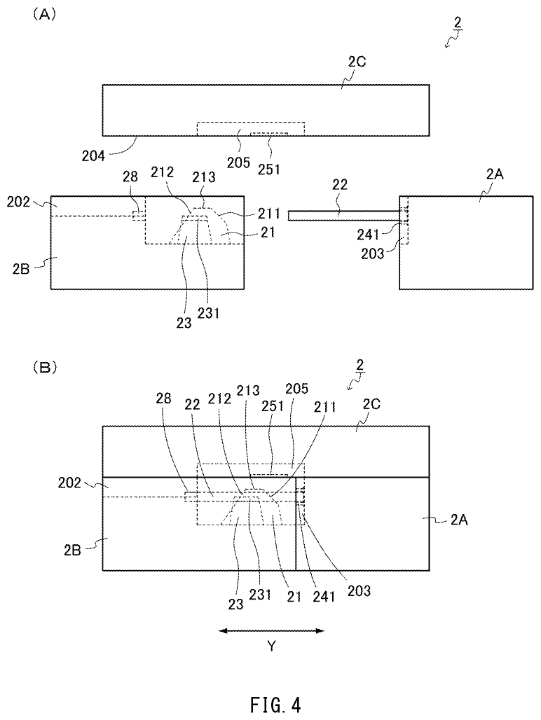

FIGS. 2 to 4 schematically show an example of the mold of the present embodiment. A mold 2 of the present embodiment is composed of three components, that is, a front mold 2A, a rear mold 2B, and an upper mold 2C. FIG. 2 is a perspective view as seen from an upper side, showing a state in which the three mold components are disassembled. In FIG. 3, FIG. 3(A) is a plan view of the front mold 2A as seen from a side that opposes the rear mold 2B, and FIG. 3(B) is a plan view of the rear mold 2B as seen from a side that opposes the front mold 2A. In FIG. 4, FIG. 4(A) is a side view showing a state in which the front mold 2A, the rear mold 2B, and the upper mold 2C are disassembled, and FIG. 4(B) is side view showing a state in which the front mold 2A, the rear mold 2B, and the upper mold 2C are assembled. In FIGS. 2 to 4, the arrow X indicates the left-right direction (also referred to as the width direction), the arrow Y indicates the front-rear direction (also referred to as the length direction), and the arrow Z indicates the height direction (also referred to as the thickness direction).

The mold 2 has the front mold 2A, the rear mold 2B, and the upper mold 2C as the mold components. During use, the mold 2 is used in a state in which these mold components are assembled. When an optical receptacle 1 is to be manufactured, the three mold components 2A, 2B, and 2C are assembled. Thus, a space that is formed by an opposing surface 203 of the front mold 2A that opposes the rear mold 2B, a first recessed portion 201 of the rear mold 2B, and a lower face 204 of the upper mold 2C constitutes a cavity of the mold 2 into which a resin is to be injected, and a space that is formed by a second recessed portion 202 of the rear mold 2B and the lower face 204 of the upper mold 2C constitutes a resin injection port that is in communication with the cavity. The opposing surface 203 of the front mold 2A that opposes the rear mold 2B serves as a surface that forms the front face 10A of the optical receptacle 1. In the rear mold 2B, an inner bottom surface of the first recessed portion 201 serves as a surface that forms the upper face 10E of the optical receptacle 1, inner lateral side surfaces of the first recessed portion 201 serve as surfaces that form the lateral side faces 10C and 10D of the optical receptacle, an opposing surface of the first recessed portion 201 that opposes the front mold 2A serves as a surface that forms the rear face 10B of the optical receptacle 1, and the lower face 204 of the upper mold 2C serves as a surface that forms the lower face 10F of the optical receptacle 1.

The front mold 2A has, in the opposing surface 203 that opposes the rear mold 2B, forming portions that form the second optical surfaces 141 of the optical receptacle 1. Specifically, the front mold 2A has lens-forming concave portions 241 that correspond to the second optical surfaces 141. The lens-forming concave portions 241 are contiguously arranged in the width direction (direction X). The shape of the lens-forming concave portions 241 is not shown in detail in FIG. 4.

The front mold 2A has a pair of pins 22 extending from the opposing surface 203, which opposes the rear mold 2B, toward the rear mold 2B. The pair of pins 22 form the pair of guide pin holes 12 in the optical receptacle 1. Each of the pins 22 is disposed outward of the lens-forming concave portions 241 for forming the second optical surfaces 141 in the width direction (direction X). Regarding the arrangement of the pair of pins 22, the pins 22 may or may not be parallel to each other, for example.

The rear mold 2B has, on the inner bottom surface of the first recessed portion 201, a protruding forming portion 21 for forming the recessed portion 11 having the reflective surface 111 in the optical receptacle 1. The protruding forming portion 21 has a shape that corresponds to the recessed portion 11 of the optical receptacle 1, and has a pair of inclined surfaces 211 and 212 that are inclined so that the distance therebetween increases in a downward direction, as well as an upper surface 213 between the inclined surfaces 211 and 212. The inclined surface 211 that is closer to the front mold 2A forms the reflective surface 111, while the corresponding inclined surface 212 forms the opposing surface 112, and the upper surface 213 forms the bottom surface 113.

The rear mold 2B has a pair of insertion openings 28 in the opposing surface of the first recessed portion 201 that opposes the front mold 2A. When the rear mold 2B and the front mold 2A are assembled, the pair of pins 22 of the front mold 2A are inserted into the pair of insertion openings 28.

The rear mold 2B further has a pair of pin-retaining portions 23 on the inner lateral side surfaces of the first recessed portion 201 and outward of the protruding forming portion 21 in the width direction (direction X). The pair of pin-retaining portions 23 are arranged at positions where the pin-retaining portions 23 come into contact with the pins 22 of the rear mold 2B when the rear mold 2B and the front mold 2A are assembled. Specifically, the pin-retaining portions 23 are each arranged so as to come into contact with the side of the corresponding pin 22 that is opposite to the opposing face thereof that opposes the other pin 22. In the rear mold 2B, the pin-retaining portions 23 each have a cutout portion 231 that extends in the front-rear direction (direction Y) and conforms to the circumferential shape of the pins 22. When the rear mold 2B and the front mold 2A are assembled, the circumferential surfaces of the pins 22 come into contact with the cutout portions 231 of the pin-retaining portions 23.

Preferably, the pin-retaining portions 23 are disposed at or near a central portion of the corresponding pins 22 in the axial direction thereof. When the pin-retaining portions 23 are disposed at or near the central portion of the corresponding pins 22, for example, during the molding of the optical receptacle 1, deformation of the pins 22 is more likely to be suppressed. Here, “disposed at a central portion of a pin 22 in its axial direction” means that a pin-retaining portion 23 is disposed at a position where the midpoint of the axial length of the pin 22 within the cavity of the mold 2 coincides with the midpoint of the axial length of a portion of the pin-retaining portion 23 that is in contact with the pin 22. Also, “near the central portion” means a region in which the midpoint of the axial length of the pin 22 and the midpoint of the axial length of the pin-retaining portion 23 are shifted from the central portion of the pin 22 in the front-rear direction by an amount of not more than 10% of the axial length of the pin 22 within the cavity of the mold 2.

The rear mold 2B has, in its upper face, the second recessed portion 202 that extends in the front-rear direction (direction Y) and is in communication with the first recessed portion 201. As described above, when the rear mold 2B and the upper mold 2C are assembled, the second recessed portion 202 constitutes the resin injection port through which a resin is to be injected into the cavity. The second recessed portion 202 is formed at a position inward of the insertion openings 28 for the pins 22 in the width direction (direction X). In the height direction (direction Z), the second recessed portion 202 may be formed at a position that is above, below, or level with the insertion openings 28 for the pins 22, for example.

The upper mold 2C has, in its lower face 204, forming portions for forming the first optical surfaces 151 of the optical receptacle 1. Specifically, the upper mold 2C has lens-forming concave portions 251 that correspond to the first optical surfaces 151. The lens-forming concave portions 251 are contiguously arranged in the width direction (direction X). The shape of the lens-forming concave portions 251 is not shown in detail in FIG. 4.

Moreover, the upper mold 2C may further have forming portions for forming the pair of protruding portions 101 that serve as the installation portions, for example. Specifically, the upper mold 2C may have a pair of recessed portions 205 along the sides on two ends thereof in the left-right direction (direction X).

As shown in FIGS. 2 and 4(A), the front mold 2A and the rear mold 2B are placed opposing each other, and as shown in FIG. 4(B), the pins 22 of the front mold 2A are inserted into the insertion openings 28 of the rear mold 2B, and the front mold 2A and the rear mold 2B are assembled. In the assembled state, each pin 22 of the front mold 2A extends, in the first recessed portion 201 of the rear mold 2B, between the corresponding pin-retaining portion 23 on the lateral side face side and the protruding portion 21, and is in contact with the cutout portion 231 of that pin-retaining portion 23 on the lateral side face side. Furthermore, the upper mold 2C is placed on top of the front mold 2A and the rear mold 2B. In this manner, the front mold 2A, the rear mold 2B, and the upper mold 2C are assembled, and thereby the resin injection port constituted by the second recessed portion 202 as well as the cavity are formed in the mold 2.

The above-described resin injection port of the mold 2 is formed by the second recessed portion 202 so that the resin flows from one end side of the pair of pins 22 toward the opposing faces of the pair of pins 22 that oppose each other, for example. The position of the resin injection port is not particularly limited. For example, it is preferable that the resin injection port is located in line with end portions of the pair of pins 22 on the one end side, and inward of the pair of pins 22 in the width direction, that is, between a direction that is parallel to an up-down direction and orthogonal to the axial direction of one of the pins 22 and a direction that is parallel to the up-down direction and orthogonal to the axial direction of the other of the pins 22. In the height direction, the position of the resin injection port may be above, below, or level with the pair of pins 22, for example.

### Method for Manufacturing Optical Receptacle

Next, a method for manufacturing an optical receptacle using the mold of the present embodiment will be described by way of examples using the drawings.

As described above, a molten resin is injected into the mold 2 in the assembled state through the resin injection port. The resin, which is used as the raw material of the optical receptacle 1, may be, for example, a transmitting resin that has the properties of transmitting light of a wavelength for use in optical communications, and specific examples thereof include, for example, transparent resins such as polyetherimide and cyclic polyolefin.

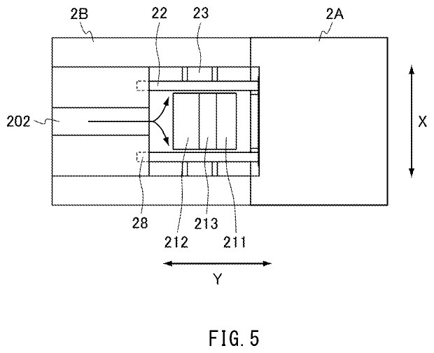

The resin that has been injected from the resin injection port of the mold 2 is introduced into the cavity. The behavior of the resin within the cavity will be described using FIG. 5. FIG. 5 is a plan view (top view) as seen from an upper side and shows a state in which the front mold 2A and the rear mold 2B are assembled. The upper mold 2C is omitted from FIG. 5.

The resin injection port of the mold 2 is formed by the second recessed portion 202 of the rear mold 2B, and the second recessed portion 202 is located between the pair of insertion openings 28 for the pins 22. Therefore, as shown in FIG. 5, when the resin is introduced into the cavity from the resin injection port, the resin flows toward a side of each of the pins 22 that opposes the other pin (directions indicated by the arrows in FIG. 5). Accordingly, stress acting outward in the width direction (direction X) is applied to each pin 22 by the flowing resin. At this time, if the rear mold 2B does not have pin-retaining portions 23 outward of the pins 22, there is a risk that the pins will bend outward due to the flowing resin. Bent pins also cause bending in the voids formed by the pins in the resulting molded body, thereby making it difficult to insert the guide pins. In contrast, in the present embodiment, since the pin-retaining portions 23 that come into contact with the pins 22 are arranged outward of the pins 22, even when a force acting outward in the width direction (direction X) is exerted by the flowing resin, bending of the pins 22 is suppressed because the pins 22 are supported by the pin-retaining portions 23. As a result, in a molded body (optical receptacle) that is obtained using the mold 2, straight voids are formed by the pins 22, and the guide pins can be inserted without any problem.

When the cavity of the mold 2 has been filled with the resin, the resin is solidified in the mold 2. The resin can be solidified through cooling, for example. After the resin has been solidified, the mold 2 is disassembled, and the molded body in the cavity is removed. Thus, an optical receptacle 1 is obtained.

As described above, the mold 2 of the present example has the pins 22 of the front mold 2A and the pin-retaining portions 23 of the rear mold 2B, and the circumferential surfaces of the pins 22 are in contact with the cutout portions 231 of the pin-retaining portions 23. Therefore, as shown in FIGS. 1(A), 1(B), 1(C), and 1(F), the optical receptacle 1 has the guide pin holes 12 formed by the pins 22 and the recessed portions 13 formed by the pin-retaining portions 23. Furthermore, in the recessed portions 13, guide walls 121 along which the guide pins of the connector are to be inserted are formed by surfaces, of the circumferential surfaces of the pins 22, that are not in contact with the cutout portions 231 of the pin-retaining portions 23. Therefore, when the guide pins of the connector are inserted into the guide pin holes 12 of the optical receptacle 1, the guide pins are exposed in the recessed portions 13. Accordingly, during use of the optical receptacle 1, for example, after the guide pins have been inserted into the guide pin holes 12, the recessed portions 13 and the guide pins exposed therein can also be solidified using an adhesive or the like. That is to say, the recessed portions 13 can be used as pockets for the adhesive. Thus, when the optical receptacle 1 is optically coupled to the optical transmitter, the optical receptacle 1 and the optical transmitter can be firmly fixed by the bonded guide pins. The adhesive is not particularly limited, and, for example, a known adhesive such as a thermosetting resin or an ultraviolet-curable resin can be used.

### Optical Module

As described above, the optical receptacle 1 that is obtained in the present embodiment is disposed between and optically connected to the optical-electrical converter and the optical transmitter, and thereby can be used as an optical module. The optical module can be used for optical communications, for example. That is to say, if the optical-electrical converter has the above-described light-emitting element, the optical module can be used for optical communications in a manner in which light that is emitted from the light-emitting element and contains communication information is directed via the optical receptacle so as to enter the optical transmitter, and if the optical-electrical converter has a light-receiving element as described above, the optical module can be used for optical communications in a manner in which light that is emitted from the optical transmitter and contains communication information is directed via the optical receptacle so as to enter the light-receiving element.

The optical-electrical converter is, for example, a device in which an optical-electrical conversion element is mounted on a substrate. The optical-electrical conversion element may be, for example, a light-emitting element or a light-receiving element. The light-emitting element is not particularly limited, and an example thereof is a laser, specifically, a surface emitting laser such as a VCSEL (vertical cavity surface emitting laser). The light-receiving element is not particularly limited, and examples thereof include a PD (photodiode) and the like. The substrate is not particularly limited, and examples thereof include a glass composite substrate, a glass epoxy substrate, a flexible substrate, and the like.

The optical transmitter is not particularly limited, and examples thereof include an optical fiber, an optical waveguide, and the like. The type of the optical fiber is not particularly limited, and examples thereof include a single-mode optical fiber, a multimode optical fiber, and the like. The number of optical transmitters optically connected to the optical receptacle is not particularly limited, and may be, for example, one, or two or more. If a plurality of optical transmitters are optically connected to the optical receptacle, the plurality of optical transmitters may be arranged such that, for example, end portions of the respective optical transmitters are lined up in a single row, or in two or more rows, with respect to the optical receptacle. The distance between the optical transmitters may be, for example, fixed or determined as desired. As described above, the number of optical-electrical conversion elements and the number of optical transmitters that are optically connected to the optical receptacle are not particularly limited, and, for example, the number of rows of optical-electrical conversion elements and the number of rows of optical transmitters may be the same. As specific examples, if, for example, the optical transmitters are arranged in a single row, it is preferable that the optical-electrical conversion elements are also arranged in a single row, and if the optical transmitters are arranged in two rows, it is preferable that the optical-electrical conversion elements are also arranged in two rows.

Although the present invention has been described with reference to the embodiments and the examples above, various modifications that will be understood by a person skilled in the art can be made to the present invention without departing from the scope of the invention. Moreover, the entire contents of documents cited in the present specification, such as patent documents and academic documents, are incorporated in the present specification by reference.

This application is based upon and claims the benefit of priority from Japanese Patent Application No. 2017-183976 filed on Sep. 25, 2017, the entire disclosure of which is hereby incorporated by reference.

### INDUSTRIAL APPLICABILITY

As described above, according to the method for manufacturing an optical receptacle as well as the optical receptacle mold of the present invention, the pins for forming the guide pin holes and the pin-retaining portions are arranged under the above-described conditions, and thereby the occurrence of bending of the pins can be suppressed during resin molding. Therefore, according to the present invention, it is possible to manufacture an optical receptacle while suppressing the occurrence of bending of the guide pin holes.

### REFERENCE SIGNS LIST

1 Optical receptacle
10 Main body
11 Recessed portion
12 Guide pin hole
141 Second optical surface
151 First optical surface
2 Mold
2A Front mold
2B Rear mold
2C Upper mold
201 First recessed portion
202 Second recessed portion
22 Pin
23 Pin-retaining portion
231 Cutout portion
28 Insertion opening

1. A method for manufacturing an optical receptacle, the method comprising:
an injection step of injecting a resin through a resin injection port of a mold into a cavity of the mold; and
a solidification step of solidifying the resin in the cavity of the mold,
the cavity of the mold having:
a protruding portion for forming a recessed portion in a main body of an optical receptacle,
a pair of pins for forming a pair of guide pin holes in the main body of the optical receptacle, and
a pair of pin-retaining portions,
wherein, in the injection step, the mold during the injection of the resin is in a state in which:
the pair of pins are respectively disposed on two end sides of the protruding portion,
the resin injection port is disposed so that the resin flows from one end side of the pair of pins toward opposing faces of the pins that oppose each other, and
one of the pin-retaining portions is disposed in contact with a side of a corresponding one of the pins that is opposite to the opposing face thereof, and the other of the pin-retaining portions is disposed in contact with a side of the other of the pins that is opposite to the opposing face thereof.

2. The method for manufacturing an optical receptacle according to claim 1, wherein, in the injection step, the mold has the resin injection port in line with end portions of the pair of pins on the one end side, and between a direction that is parallel to an up-down direction and orthogonal to an axial direction of one of the pins and a direction that is parallel to the up-down direction and orthogonal to an axial direction of the other of the pins at the end portions.

3. The method for manufacturing an optical receptacle according to claim 1, wherein, in the injection step, in the mold, the pin-retaining portions are each disposed at or near the center of a corresponding one of the pins in an axial direction thereof.

4. An optical receptacle mold which has a cavity for molding an optical receptacle,
the cavity having:
a protruding portion for forming a recessed portion in a main body of an optical receptacle,
a pair of pins for forming a pair of guide pin holes in the main body of the optical receptacle, and
a pair of pin-retaining portions,
the pair of pins being respectively disposed on two ends of the protruding portion,
a resin injection port being disposed so that the resin flows from one end side of the pair of pins toward opposing faces of the pins that oppose each other, and
one of the pin-retaining portions being disposed in contact with a side of a corresponding one of the pins that is opposite to the opposing face thereof, and the other of the pin-retaining portions being disposed in contact with a side of the other of the pins that is opposite to the opposing face thereof.

5. The mold according to claim 4, wherein the mold has the resin injection port in line with end portions of the pair of pins on the one end side, and between a direction that is parallel to an up-down direction and orthogonal to an axial direction of one of the pins and a direction that is parallel to the up-down direction and orthogonal to an axial direction of the other of the pins.

6. The mold according to claim 4, wherein the pin-retaining portions are each disposed at or near the center of a corresponding one of the pins in an axial direction thereof.
